(19) United States
(12) Patent Application Publication
(10) Pub. No.: US 2009/0079427 A1
(43) Pub. Date: Mar. 26, 2009

(54) MULTIPLY PHASE-CYCLED STEADY STATE FREE PRECESSION SEQUENCE AND MAGNETIC RESONANCE APPARATUS FOR IMPLEMENTATION THEREOF

(76) Inventor: Michael Deimling, Moehrendorf (DE)

Correspondence Address: SCHIFF HARDIN, LLP;PATENT DEPARTMENT, 6600 SEARS TOWER, CHICAGO, IL, 60606-6473, US

(21) Appl. No.: 12/238,808

(22) Filed: Sep. 26, 2008

(30) Foreign Application Priority Data
Sep. 26, 2007 (DE) 10 2007 045 996.5

(51) Int. Cl. G01V 3/14

(52) U.S. Cl. 324/307

(57) ABSTRACT

A multiply phase-cycled steady state free precession sequence has at least two sub-sequences with alternating radio-frequency excitation pulses. An intermediate image data set is generated from raw data that are acquired with each sub-sequence. A resulting image data set is formed from the intermediate image data sets. Radio-frequency excitation pulses for different sub-sequences have supplementary phases differing from one another, such that successive radio-frequency excitation pulses cannot lead to a non-alternating excitation in any sub-sequence. A magnetic resonance apparatus has a corresponding apparatus controller that implements the sequence.

### BACKGROUND OF THE INVENTION

1. Field of the Invention

The present invention is in the field of magnetic resonance tomography (MRT), as applied in medicine for examination of patients.

The present invention more specifically concerns a multiply phase-cycled steady state free precession sequence (SSFP sequence) (imaging method) of the type composed of at least two sub-sequences with alternating radio-frequency excitation pulses, wherein an intermediate image data set is generated from raw data that are acquired with every sub-sequence, and wherein a result image data set is formed from the intermediate image data sets. The invention also concerns a magnetic resonance apparatus for implementation of such method.

2. Description of the Prior Art

Image artifacts that are caused by local inhomogeneities of the basic magnetic field B₀ occur in SSFP sequences (among which is the sequence known as the True FISP sequence). The inhomogeneities generate interferences that are visible as banding artifacts in the image. The banding artifacts occur at points in the image field at which the precession angle of the transverse magnetization assumes the value π or 180° within the repetition time TR. The precession angle is defined in a reference coordinate system that rotates with the resonance frequency.

An appropriate way to reduce these interfering artifacts is to reduce the repetition time TR, but there are regions with high inhomogeneities (in particular given the use of high basic magnetic fields B₀) where this measure can no longer be implemented. The fast gradient fields required for shorter repetition times TR additionally cause the gradient system to run up against its performance limits at high image resolution. Additionally, an increase of the readout bandwidth with a loss in the signal-to-noise ratio occurs with a reduction of the repetition time.

The problems described in the preceding, caused by inhomogeneities, are partially solved by the CISS excitation scheme (Constructive Interference in Steady State). The CISS sequence is used for high-resolution T₂ imaging via which in particular fluids (due to the advantageously small T₁/T₂ ratio) can be measured with very high intensity.

The CISS sequence is generally based on multiple or N-tuple measurements (acquisitions) of a 2D or 3D True FISP data set with respective modified radio-frequency excitation scheme, as it is described in DE 40 04 185 A1 (corresponding to U.S. Pat. No. 5,034,692), for example. At most four different schemes (N=4) are presently used.

The combination of phase-alternating radio-frequency excitation pulses with non-phase-alternating radio-frequency excitation pulses (N=2) represents the simplest case of a CISS sequence. This delivers two different data sets, and each of these data sets normally inherently has the typical banding artifacts (signal minima) of a True FISP sequence. Additional details are described in DE 40 04 185 A1, cited above.

These artifacts can be reduced by processing the complex raw data that were acquired with the various radio-frequency excitation schemes. The artifacts can also be reduced through an additional processing of the image data, thus according to the Fourier transformation of the raw data acquired with the sequences. In US 2005/0030023 A1 it is proposed to first differently weight and subsequently to combine the acquired images for pixel-by-pixel artifact reduction in SSFP sequences. The sum-of-squares (SOS) method and the maximum intensity projection method are applied there in the magnitude images. In each case, however, a residual error or a residual ripple remains in the resulting image with regard to amplitude and location.

A multiply phase-cycled steady state free precession sequence of the aforementioned type is known from DE 10 2004 025 417 A1, which was also published as US 2005/0258830 A1. There a method is described with which the image homogeneity of multiply phase-cycled SSFP sequences can be further improved. Both the sum-of-squares and the maximum intensity projection are formed from the image data of the appertaining sequences. A result image optimized with regard to homogeneity is obtained via per-pixel combination of the sum-of-squares image and the MIP image. In some cases, however, visible artifacts remain in the images even with this method.

### SUMMARY OF THE INVENTION

An object of the present invention is to provide a method (pulse sequence) with which the image homogeneity and the signal-to-noise ratio are additionally improved for multiply phase-cycled SSFP sequences. A further object of the invention is to provide a magnetic resonance apparatus with which the method can be executed.

In accordance with the invention, a multiply phase-cycled steady state free precession sequence with at least two sub-sequences with alternating radio-frequency excitation pulses is employed, wherein an intermediate image data set is generated from raw data that are acquired with each sub-sequence, and wherein a resulting image data set is formed from the intermediate image data sets, and the radio-frequency excitation pulses have supplementary phases differing from one another for different sub-sequences, such that successive radio-frequency excitation pulses cannot lead to non-alternating excitation in any sub-sequence.

The above object also is achieved by a magnetic resonance imaging apparatus having a sequence controller, or a computer program distributed among a number of control computers for implementing a sequence as described above.

The invention proceeds from the insight that the homogeneity is already sufficiently high over a large range within the imaging region (field of view, FOV) after an adjustment or after a shimming of the basic magnetic field B₀. Image artifacts then occur only in border regions of the FOV and at points where the basic magnetic field still significantly deviates from the reference value due to anatomical conditions (such as, for example, in the area of the petreous bone or the Achilles tendon.

As was mentioned above, in an SSFP sequence the signal minima occur at the points at which the precession angle of the transverse magnetization assumes the value π within the repetition time TR. If an auxiliary phase is added to the phase-alternating radio-frequency excitation pulse, this has the effect of an additional frequency shift on the SSFP transverse magnetization. The artifacts are displaced into regions outside of the FOV.

### DESCRIPTION OF THE DRAWINGS

FIG. 1 is an overview representation showing the basic design of a diagnostic magnetic resonance apparatus with an apparatus controller to implement an embodiment of the inventive method.

FIG. 2 schematically illustrates the sequence of radio-frequency excitation pulses and gradient pulses in a first sub-sequence of a CISS 3D sequence.

FIG. 3 schematically illustrates the sequence of radio-frequency excitation pulses and gradient pulses in a second sub-sequence of a CISS 3D sequence.

FIG. 4 shows the curve of an SSFP magnitude signal, dependent on the dephasing angle or the frequency deviation from the nominal frequency due to inhomogeneities.

FIG. 5 is a graphical representation of a measurement of a phantom for the case of an alternating excitation.

FIG. 6 is a graphical representation of a measurement of the same phantom as in FIG. 5, for the case of a non-alternating excitation.

FIG. 7 is a graphical representation of a measurement of the same phantom as in FIG. 5, with a supplementary phase of the radio-frequency excitation pulses of a first sub-sequence.

FIG. 8 is a graphical representation of a measurement of the same phantom as in FIG. 5, with a supplementary phase of the radio-frequency excitation pulses of a second sub-sequence.

FIG. 9 shows basic steps of a multiply (N-tuple) phase-cycled SSFP sequence in an overview.

### DESCRIPTION OF THE PREFERRED EMBODIMENTS

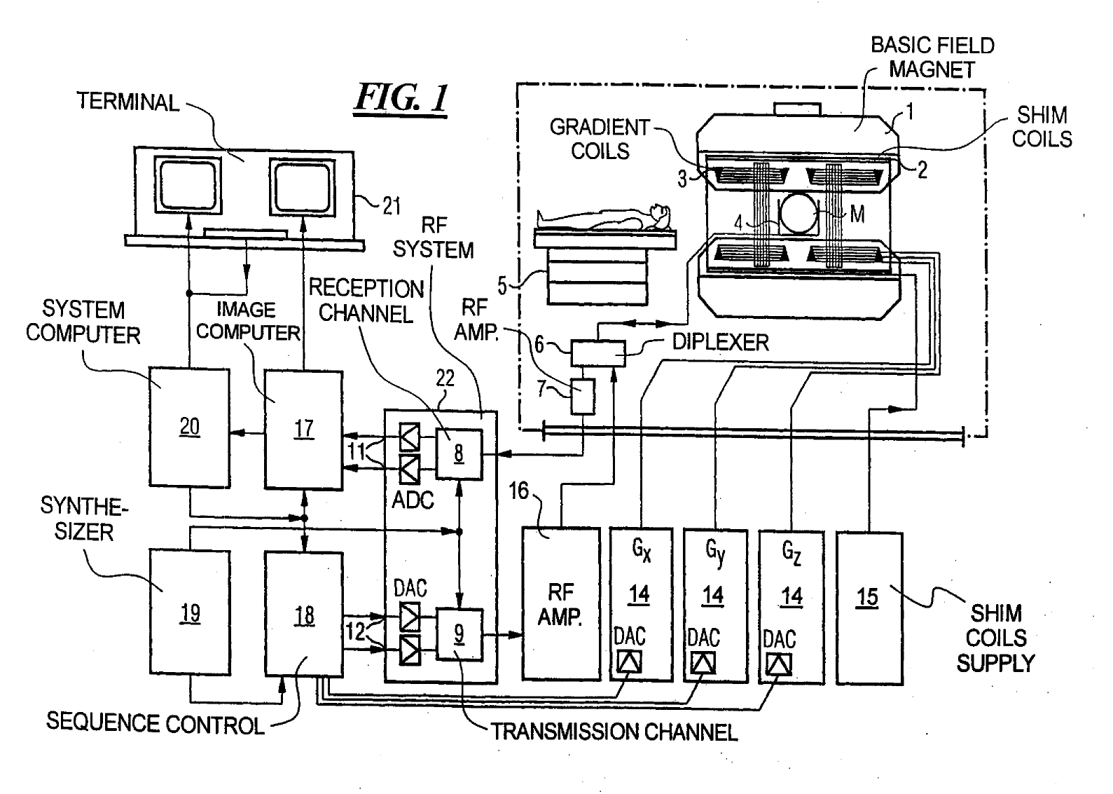

FIG. 1 shows a schematic representation of a magnetic resonance apparatus for generation of a magnetic resonance image of a subject according to the present invention. The design of the nuclear magnetic resonance tomography apparatus corresponds to the design of a conventional tomography apparatus, with the exceptions noted below. A basic magnetic field 1 generates a temporally constant, strong magnetic field for polarization or, respectively, alignment of the nuclear spins in the examination region of a subject (such as, for example, a portion of a human body to be examined). The high homogeneity of the basic magnetic field that is required for the nuclear magnetic resonance measurement is defined in a spherical measurement volume M into which the portions of the human body to be examined are introduced. Components known as shim plates (not shown) made from ferromagnetic material are applied at suitable points to support the homogeneity requirements and in particular to eliminate temporally invariable influences. Temporally variable influences are eliminated by shim coils 2 that are controlled by a shim power supply 15.

A cylindrical gradient coil system 3 formed by three sub-windings is embodied in the basic field magnet 1. Each sub-winding is provided by an amplifier 14 with current to generate a linear gradient field in the respective direction of the Cartesian coordinate system. The first sub-winding of the gradient field system 3 thereby generates a gradient Gₓ in the x direction; the second sub-winding generates a gradient G_{y} in the y direction; and the third sub-winding generates a gradient G_{z} in the z direction. Each amplifier 14 has a digital/analog converter that is activated by a sequence controller 18 for accurately timed generation of the gradient pulses.

Located within the gradient coils 3 is a radio-frequency antenna 4 that converts the radio-frequency pulses emitted by a radio-frequency power amplifier 16 into an alternating magnetic field to excite the nuclei and align the nuclear spins of the subject to be examined or, respectively, of the region of the subject to be examined. The alternating field emanating from the precessing nuclear spins, i.e. normally the nuclear spin echo signal caused by a pulse sequence made up from one or more radio-frequency pulses and one or more gradient pulses, is converted into a voltage that is supplied via an amplifier 7 to a radio-frequency reception channel 8 of a radio-frequency system 22. The radio-frequency system 22 furthermore has a transmission channel 9 in which the radio-frequency pulses for the excitation of the nuclear magnetic resonance signals are generated. In the sequence controller 18, the respective radio-frequency pulses are represented digitally as a series of complex numbers based on a pulse sequence predetermined by the system controller 20. This number series is supplied as a real part and as an imaginary part via respective inputs 12 to a digital/analog converter in the radio-frequency system 22, and from this to a transmission channel 9. In the transmission channel 9 the pulse sequences are modulated to a radio-frequency carrier signal whose base frequency corresponds to the resonance frequency of the nuclear spins in the measurement volume.

The switching from transmission operation to reception operation ensues via a transmission-reception diplexer 6. The radio-frequency antenna 4 radiates the radio-frequency pulses for excitation of the nuclear spins into the measurement volume M and samples resulting echo signals. The correspondingly acquired nuclear magnetic resonance signals are phase-sensitively demodulated in a reception channel 8 of the radio-frequency system 22 and are converted into real part and imaginary part by a respective analog/digital converter. An image is reconstructed by an image computer 17 from the measurement data acquired in this manner. The administration of the measurement data, the image data and the control programs ensues through the system computer 20. The sequence controller 18 monitors the generation of the respective desired pulse sequences and the corresponding scanning of k-space based on a specification with control programs. The sequence controller 18 in particular controls the accurately timed switching of the gradients, the emission of the radio-frequency pulses with defined phase and amplitude and the acquisition of the nuclear magnetic resonance signals. The time base for the radio-frequency system 22 and the sequence controller 18 is provided by a synthesizer 19. The selection of corresponding control programs to generate a magnetic resonance image, as well as the representation of the generated magnetic resonance image, ensue via a terminal 21 that has a keyboard and one or more monitors.

The magnetic resonance tomography apparatus is operated with a modified CISS pulse sequence in an embodiment of the invention. This modified CISS pulse sequence is generated by the sequence controller 18. The implementation of the method according to the invention ensues in the sequence controller 18, in the image computer 17 and/or in the system computer 20.

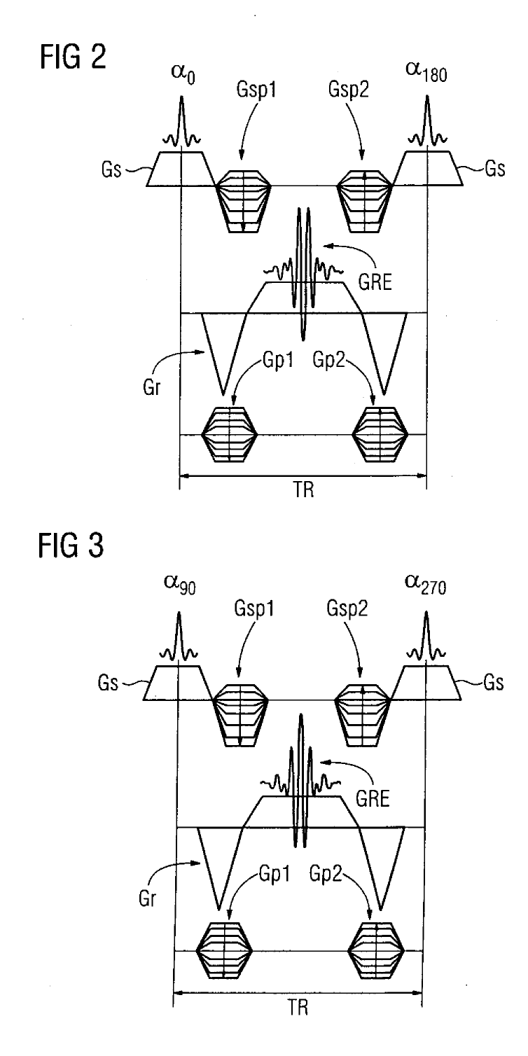

As was mentioned above, the combination of two True FISP sequences represents the simplest case of a conventional CISS sequence with N=2, wherein the first sub-sequence has phase-alternating radio-frequency excitation pulses and the second sub-sequence has non-phase-alternating radio-frequency excitation pulses. For example, in the following a 3D CISS sequence is described. The first True FISP sequence with phase alternation is shown in FIG. 2, i.e. positive and negative radio-frequency excitation pulses α0 and α180 are generated in alternation. A gradient Gs is generated simultaneously with the radio-frequency excitation pulses α0 and α180. The phase coding here ensues step-by-step in two directions perpendicular to one another with the gradient pulses Gsp1 and Gp1. A frequency coding with the gradient pulse sequence Gr ensue scintillator the readout direction. In the stationary or steady state, the spatially coded magnetic resonance signal GRE is acquired and digitized as a raw signal in the middle between the two radio-frequency excitation pulses α0 and α180. Additional gradient pulses Gsp2 and Gp2 follow, such that the gradient time integral of all gradient pulses between two successive radio-frequency excitation pulses is zero. This pulse series corresponds to a conventional True FISP sequence.

The pulse series of a second sub-sequence is presented in FIG. 3. The second sub-sequence has proceeded from the first sub-sequence by the radio-frequency excitation pulses including a supplementary phase that lies between 0° and 180°, thus in the middle between the alternating radio-frequency excitation pulses. The second sub-sequence is thus characterized by successive radio-frequency excitation pulses α90 and α270. The remaining pulses in the second sub-sequence are unchanged relative to the first sub-sequence. The two pulse series presented in FIG. 2 and FIG. 3 are repeated with the repetition time TR until k-space has been completely populated with data with each sub-sequence.

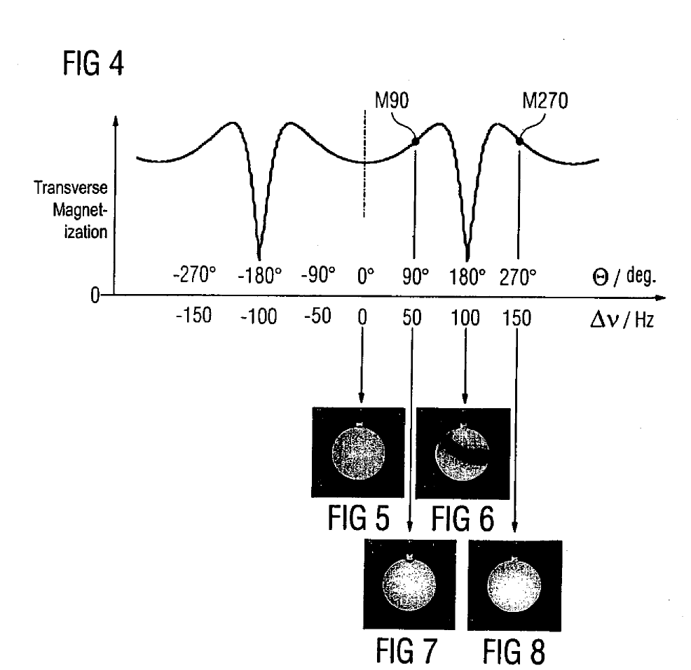

FIG. 4 shows the curve of an SSFP magnitude signal of the transverse magnetization dependent on the dephasing angle θ or the frequency deviation Δv from the nominal frequency due to inhomogeneities given a doubly phase-cycled SSFP sequence. The signal response was simulated with the following parameters:

TR=4ms

α=40°

T1=3s

T2=2.2s

A corresponding phase increment as a supplementary phase of the radio-frequency pulse has the same effect as the dephasing angle θ. Therefore signal cancellations occur at a phase increment of 180°, which is equivalent to a non-alternating radio-frequency excitation: the measurable transverse magnetization is vanishingly small. Signal cancellations in the transverse magnetization signal are avoided by the supplementary phase θ of 90°, which avoids a non-alternating radio-frequency excitation. The values of the transverse magnetization that are determined by the supplementary phases θ 90° and 270° are labeled with M90 and M270, respectively.

Image exposures of a phantom that were generated with various supplementary phases θ of the radio-frequency excitation pulses are presented in FIGS. 5 through 8.

FIG. 5 shows an image acquisition for the alternating case with a supplementary phase of 0°, and FIG. 6 shows the non-alternating case with a supplementary phase of 180°. While no banding artifacts are visible in the base of the alternating radio-frequency excitation in FIG. 5, the banding artifacts due to inhomogeneities in the conventional CISS sequence are clearly recognizable in FIG. 6 in the base of the non-alternating radio-frequency excitation.

FIG. 7 shows an image exposure of the phantom in the case of the supplementary phase of 90°, and FIG. 8 shows the case of the supplementary phase of 270°. A clear reduction of the banding artifacts can be established.

In the general case of an N-times phase cycling, the supplementary phase is determined as follows. In the cases of an even number of sub-sequences,

Θᵢ^{g}=(360°/N)×(1/2+i),

and in the case of an odd number of sub-sequences,

Θᵢ^{u}=(360°/N)×i.

N is the number of sub-sequences and i is an index for every sub-sequence that runs from o to (N−1).

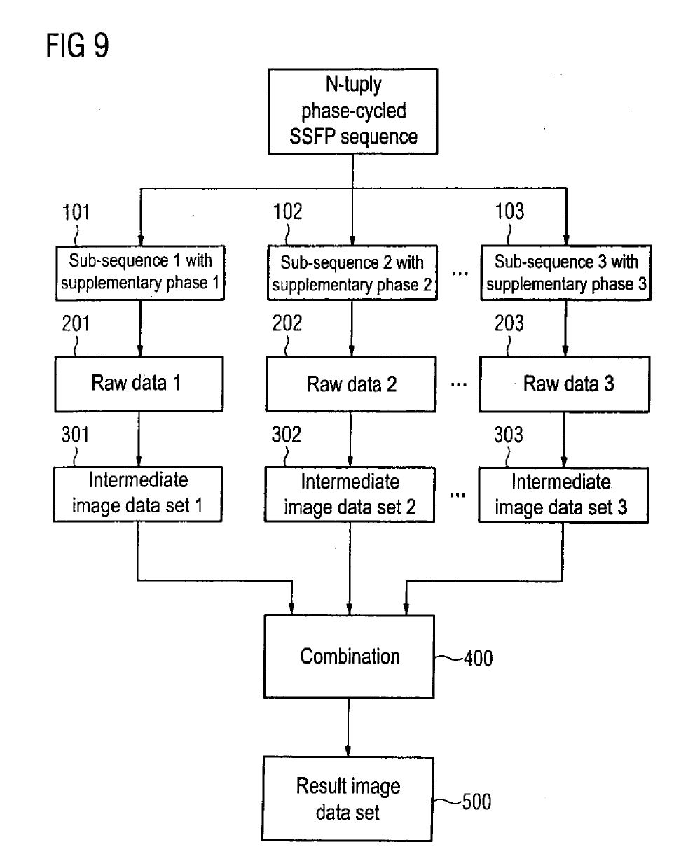

FIG. 9 shows basic steps of a multiply (N-tuply) phase-cycled SSFP sequence in an overview. As described in the preceding, sub-sequences 101, 102, 103 with various supplementary phases are correspondingly used with an N-tuply phase-cycled SSFP sequence to acquire raw data 201, 202, 203. The raw data 201, 202, 203 are the magnetic resonance signals spatially coded with the gradient pulses that are then imported into a k-space data matrix corresponding to their coding. N intermediate image data sets 301, 302, 303 that are combined pixel-by-pixel into a result image data set 500 in an image processing step 400 are generated after a Fourier transformation and absolute valuation.

The resulting image data set 500 is formed either by a pixel-by-pixel summation of the squared absolute values or by a pixel-by-pixel formation of the maximum intensity projection value of the intermediate image data sets 301, 302, 303. The resulting image data set 500 can also be generated by a combination of the two preceding methods, as described in DE 10 2004 025 412 A1 (cited above).

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for acquiring magnetic resonance data comprising the steps of:
exposing an examination subject to a multiply phased-cycled steady state free precession sequence comprising at least two sub-sequences respectively with alternating radio-frequency excitation pulses;
in said multiply phased-cycled steady state free precession sequence, emitting radio frequency excitation pulses respectively for different ones of said sub-sequences that have supplementary phases that are different from each other that preclude successive ones of said radio frequency excitation pulses from causing a non-alternating excitation in any of said sub-sequences;
acquiring a raw data set from each of said sub-sequences following excitation by said radio frequency excitation pulses;
generating an intermediate image data set respectively from said raw data sets; and
combining said intermediate image data sets to produce a resulting image data set and making said resulting image data set available as an output in a form suitable for reconstructing an image of the examination subject therefrom.

2. A method as claimed in claim 1 comprising determining the supplementary phase of the respective radio-frequency excitation pulses for each sub-sequence dependent of a number of said sub-sequences and an index of the sub-sequence for which the supplementary phase is being determined.

3. A method as claimed in claim 2 comprising determining the supplementary phase for each sub-sequence according to the relationship
Θᵢ^{g}=(360°/N)×(1/2+i),
in the case of an even number of sub-sequences and according to the relationship
Θᵢ^{u}=(360°/N)×i
in the case of an odd number of sub-sequences, wherein N is the number of sub-sequences and i is an index for every sub-sequence that runs from 0 to (N−1).

4. A method as claimed in claim 1 comprising generating the resulting image data set from said intermediate data sets according to a sum-of-squares method applied pixel-by-pixel.

5. A method as claimed in claim 1 comprising generating the resulting image data set from said intermediate data sets according to a maximum intensity projection method applied pixel-by-pixel.

6. A method as claimed in claim 1 comprising determining a first intermediate resulting image data set from said intermediate image data sets according to a sum-of-squares technique applied pixel-by-pixel, and generating a second intermediate resulting image data set from said intermediate image data sets according to the maximum intensity projection technique applied pixel-by-pixel, and generating said resulting image data set by combining said first intermediate resulting image data set and said second intermediate resulting image data set.

7. A magnetic resonance apparatus for acquiring magnetic resonance data comprising:
a magnetic resonance scanner that interacts with a subject o acquire magnetic resonance data therefrom;
a controller that operates said magnetic resonance scanner to expose the subject to a multiply phased-cycled steady state free precession sequence comprising at least two sub-sequences respectively with alternating radio-frequency excitation pulses;
said controller being configured to cause, in said multiply phased-cycled steady state free precession sequence, radio frequency excitation pulses to be emitted in said scanner respectively for different ones of said sub-sequences that have supplementary phases that are different from each other that preclude successive ones of said radio frequency excitation pulses from causing a non-alternating excitation in any of said sub-sequences;
said controller being configured to operate said scanner to acquire a raw data set from each of said sub-sequences following excitation by said radio frequency excitation pulses;
a computer configured to generate an intermediate image data set respectively from said raw data sets, and to combine said intermediate image data sets to produce a resulting image data set and make said resulting image data set available as an output in a form suitable for reconstructing an image of the examination subject therefrom.
